(19) United States
(12) Patent Application Publication
(10) Pub. No.: US 2009/0201767 A1
(43) Pub. Date: Aug. 13, 2009

(54) Battery Assembly Module for the ShotWatch™

(76) Inventor: Theodore Weissenburger Caldwell, Laguna Beach, CA (US)

Correspondence Address: THEODORE WEISSENBURGER CALDWELL, 1414 MORNINGSIDE DR., LAGUNA BEACH, CA, 92651, US

(21) Appl. No.: 12/028,412

(22) Filed: Feb. 8, 2008

(51) Int. Cl. G04B 37/00; G04B 47/06

(52) U.S. Cl. 368/10; 368/276

(57) ABSTRACT

The power source for the Shotwatch™, a wrist worn, microprocessor based swing monitor, is a three volt, coin sized battery such as the Duracell DL 2032. Given the voltage requirements of the swing monitor, as well as the size and space constraints imposed by the wrist watch embodiment, a newly designed battery assembly was required. The assembly was patterned after a common Compact Disc/DVD carriage which would allow easy replacement by the user. Additionally, the carriage needed to be designed with fail-safes such as making it difficult or impossible to insert the battery or the carriage itself incorrectly, resulting in serious damage or destruction of the Shotwatch™. Contact points, springs and release mechanisms were deployed in an optimal manner to accomplish the dual objectives of a reliable power source and an assembly that would prove viable in possible hostile environments.

### BRIEF DESCRIPTION OF THE DRAWINGS

FIG. 1 illustrates the Shotwatch™ body and where the battery holder tray slides into the wrist watch swing monitor.

FIG. 2 illustrates the tray release mechanism. By inserting a pointed object such as a ball point pen or golf tee in the side orifice, a piston like rod pushes the tray outside the watch as shown. This enables the user to grip the tray with their fingers and remove it for the purpose of a) changing the battery, or b) for rebooting the Shotwatch™.

FIG. 3. The battery tray slides into the Shotwatch™ and makes contact with a conductor strip soldered to the watch's P C Board. (Housing not shown here.)

FIG. 4. On both sides of the piston expandable clamp like jaws hold the tray in place inside the module. Complementary clamps are fitted onto the tray such that when the tray is docked in the module, it will not slip out.

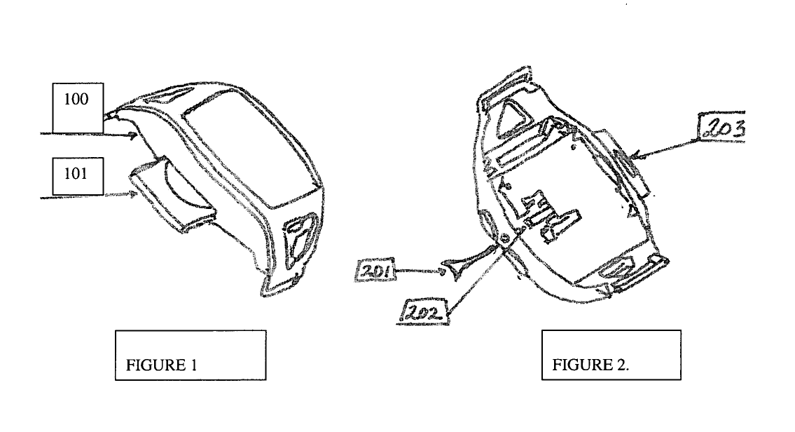

FIG. 1.01 illustrates the wrist worn swing monitor and the position of the battery tray. In the tray itself 1.02, notches on the outer edges of the tray prevent the tray from being inserted upside down which would result in reverse polarity of the battery. Complementary notches are cast into the watch body.

The reverse side of the Shotwatch is depicted in FIG. 2. 2.01 illustrates the insertion of a golf tee or any pointed object into an orifice that pushes a piston (2.02 past interlocking jaw like clamps and partially releases the tray from its dock. From this position the tray (2.03) can be manually gripped and completely removed.

The details of the tray are illustrated in FIG. 3. Note how the outer edges of the tray (3.01) are notched for fitting properly. Also note the ridge inside the tray such that the coin cell will fit flush inside the tray. A copper contact plate (3.03) is soldered to the circuit board (3.02) of the Shotwatch. A semi-circular or curved spring copper contact strip (3.04) is pressed against the circuit board plate when the tray is locked into position.

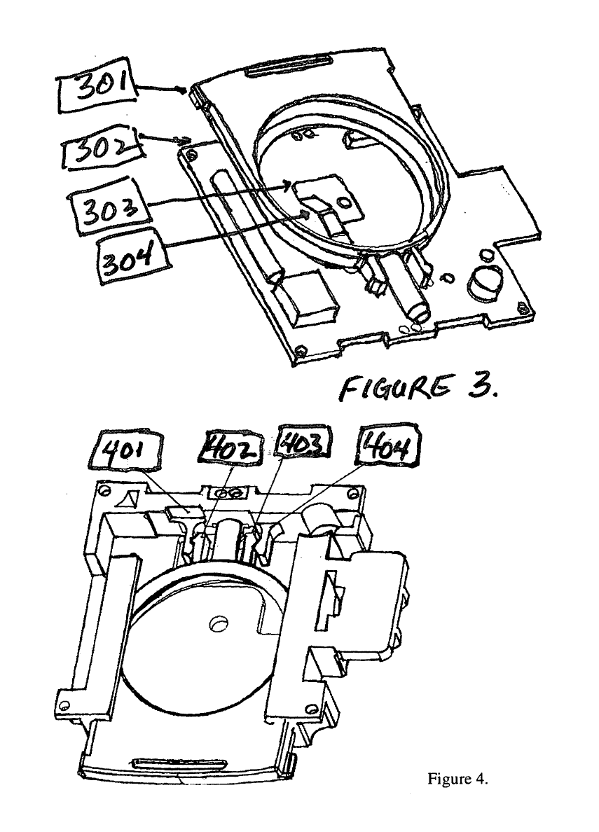

FIG. 4 illustrates the housing the battery tray slides into. The housing is mounted to the circuit board and secured by four metal screws. On both sides of the tray stem or handle are outward facing clamps (4.02 and 4.03) The complementary inward facing clamps (4.01 and 4.04) are molded into the inside top of the housing.

### BRIEF DESCRIPTION OF THE PREFERRED EMBODIMENT.

A coin cell 3 volt battery snaps snuggly into a receiving tray which is notched to accommodate the seam in the manufactured battery. The tray has two legs on both sides and on the ends of the legs are feet which function as expandable clamps holding the tray in place. The end of the tray exposed to the outside of the watch is configured in such a way that in can not be inserted into the watch upside down.

Once inside the watch, the tray can be released by inserting the tip of a ball point into an orifice on the opposite side of the watch. This pushes a piston that removes the tray from its docking station. Enough of the tray is revealed so that the wearer can grip the tray with his or her fingers and completely remove it from the watch.

The contact point for the battery is a flexible metal strip soldered to the PC board. The entire battery tray housing is secured by screws to the PC board. The preferred material for the tray and housing is PVC plastic.

1. A coin sized, three volt battery assembly, consisting of a carriage tray, a release piston, two spring-like contact points, and clamp like safety latches all housed in a module fastened to a P C board, constitutes the instant invention. The entire battery assembly (module) fits inside a wrist watch like, micro-processor based, swing monitor commercially known as the Shotwatch™. The tray is completely removable. The battery lays flat in the tray and ridges inside the circular portion of the tray prevent the battery from being inserted into the tray upside down. Furthermore, the tray itself is designed with a distinctive upside and downside. The slot the tray slides into is configured so that the tray can only be inserted right-side up. The positive and negative contact points for the battery are semi-circular metal strips, analogous to those commonly found in flashlights, and are soldered both above and below the contact points on the battery. The release mechanism is a piston like cylinder manually operated by inserting a pointed object, such as a ball point pen or a golf tee into an orifice on the side of the Shotwatch™ opposite the side the tray is inserted into. This releases spring-like clamps which hold the battery in place inside the module, and pushes the tray far enough outside the module to be grasped with the fingers and completely removed from the Shotwatch™.

2. Shotwatch™ in claim 1 refers to a microprocessor based, golf swing monitor worn on the wrist and having an appearance analogous to a common sport watch.

3. The assembly recited in claim 1 holds and operates a battery/power source for a wrist watch swing monitor.

4. Module in claim 1 refers to the carriage or housing the tray slides into and out of.

5. Tray in claim 1 refers to a specifically designed holder for placing a 3 volt, coin sized battery into.

6. Piston in claim 1 refers to a push rod accessed by inserting a slim, pointed object such as a golf tee or a ball point pen into an orifice in the side of the Shotwatch™.

7. Spring like clamps in claim 1 refers to expandable jaws that grasp the tray and hold it in place inside the module.
